(19) United States
(12) Patent Application Publication
(10) Pub. No.: US 2022/0135453 A1
(43) Pub. Date: May 5, 2022

(54) PROCESS FOR CONTROLLING AND REGULATING THE INJECTION OF CO2 IN ORDER TO TREAT AN EFFLUENT

(71) Applicant: Air Liquide France Industrie, Paris (FR)

(72) Inventors: Bruno ALBAN, Verrières le Buisson (FR); Dominique BRAS, Brécey (FR); Philippe CAMPO, Montigny le Bretonneux (FR)

(21) Appl. No.: 17/518,293

(22) Filed: Nov. 3, 2021

(30) Foreign Application Priority Data
Nov. 4, 2020 (FR) 2011316

(51) Int. Cl. C02F 1/68

(52) U.S. Cl. CPC C02F 1/68; C02F 2201/002; C02F 2209/06

(57) ABSTRACT

A process for treatment of an effluent, which comprises an injection (3) into the effluent, of CO₂ or of a mixture comprising CO₂, comprising:
a. a measurement of the pH (6) of the effluent is carried out upstream of the point of injection of the CO₂ or of the mixture in the process;
b. a curve of dose of CO₂ to be injected as a function of the pH of a medium for a predetermined volume in litres or in cubic metres was determined beforehand, and this curve is entered into a regulator or automaton (4) capable of controlling the operation of the process;
c. the presence of a flow of effluent to be treated is detected, and the dose of CO₂ or of mixture, determined by said curve and multiplied by the flow rate of effluent to be treated, is injected.

### CROSS REFERENCE TO RELATED APPLICATIONS

This application claims the benefit of priority under 35 U.S.C. § 119 (a) and (b) to French Patent Application No, 2011316, filed Nov. 4, 2020, the entire contents of which are incorporated herein by reference.

### TECHNICAL FIELD

The present invention relates to the field of the treatment of high pH waters, which pH it is desired to lower by injecting CO₂, which is regarded as a weak diacid.

### BACKGROUND

In order to do this, in general, in the absence of a contact basin/tank, the CO₂ is injected more or less effectively into the water/the effluent in-line in a pipeline conveying the water/the effluent, by virtue of an injector, for example a simple pierced pipe or also an injector of more elaborate structure.

This is because it is known that, depending on the industrial installation under consideration, such a basin is not available and it is not possible to position one therein, essentially for lack of space.

It can then, under some conditions, be problematic to guarantee consistency of the treatment, by taking a pH measurement downstream of the injection: for example during start-up, or also during short-lived discharges or also during a sudden variation in the pH of the incoming effluent.

Currently, in this industry, the process is controlled by a pH measurement placed downstream of the injection. Regulation of the CO₂ flow rate is carried out by an automaton/controller, which will adjust the CO₂ flow rate depending on the result obtained, namely the difference between the pH measurement obtained and a desired value or setpoint.

Regulation can be more or less precise and reactive by virtue of conventional PID-type parametering, for example.

Thus:
If the pH is too high with respect to the setpoint, the maximum opening of the regulation valve is generally ordered in order to have the maximum CO₂ flow rate.
If the pH falls and thus approaches the setpoint, a decrease in the flow rate, indeed even closure of the regulation/injection valve, is generally ordered.
If the pH passes below the setpoint value, the CO₂ flow rate becomes zero.

The entire art of the designer will be to find the right method of regulation and to satisfactorily parameterize it in order to keep the value of corrected pH in the vicinity of the setpoint or at the setpoint for the maximum possible time.

Unfortunately, this can prove to be problematic, for example in the case where the operation is highly sequenced, that is to say, for example, when the effluent to be neutralized is sent by a pump into the pipeline where the injection of CO₂ takes place with the pump being set going numerous times over short periods. The volume of effluent contained between the pump and the location of the probe making possible control of the pH and regulation of the injection will not be treated, this being the case at each start-up of the pump. If the pump is set going several times per hour, as is the case in numerous installations, where the pump is located in a small inspection hole and makes possible the discharge of the effluent into a drainage system, the volume accumulated on each start-up will not be treated, or in any case not correctly.

### SUMMARY

The present invention then attempts to provide a solution to the abovementioned technical problems, and thus to provide an improved process for the treatment of waters, employing an injection of CO₂, whether this CO₂ is in the gas or liquid form.

And while without any doubt a pure gas is preferred according to the invention, it is possible to envisage gas mixtures comprising at least 25% of CO₂.

As will be seen in more detail in what follows, the present invention carries out a measurement of the incoming pH (i.e. taken well upstream of the injection, which allows time to react according to the result of the measurement), and then the dose of CO₂ to be applied is calculated, in a predictive way.

It should be considered that the pH measurement is carried out sufficiently upstream of the injection very simply in order for the pH measurement point not be disrupted by the downstream injection.

Generally, a typical effluent exhibits a typical curve of dose of CO₂ to be injected as a function of the pH of the effluent for a predetermined volume in litres or in cubic metres.

This curve is obtained either from calculations based on analyses of composition (commercial software is available for this or very simply by a conventional pH calculation in order to determine the CO₂ requirement and thus the neutralization curve), or from tests carried out in the laboratory.

These tests consist of a conventional acid/base volumetric titration using a burette or a pH calculation following the rules of the art which makes it possible to determine the amount of acid to be injected.

For CO₂, depending on the technical solution proposed, the real amount injected corresponds to the theoretical requirement (as evaluated above) divided by the transfer efficiency.

Thus, for an in-line injection, the efficiency is regarded as being between 90% and 95%. Thus, with the preceding titrimetric assaying, typically 10% is added.

The dose thus determined is multiplied by the effluent flow rate. This flow rate is either fixed and corresponds to the flow rate of the pump, or variable; it is then measured by a flowmeter placed immediately after the pump. The curve thus determined is supplied to the intelligence or the automaton/calculator, which will then manage the injection.

The improvement which the proposal according to the present invention constitutes is then understood without difficulty since in fact, for an in-line neutralization, by working on data available before the injection, it is much easier to guarantee good dosing of CO₂ from the starting up of the discharge pump, this being the case whatever happens.

This is particularly true in the case of a rapid and frequent emptying of a pit or sink containing an effluent or water which is alkaline (pH greater than 7, for example). The liquid will be immediately treated with the right flow rate of CO₂ from its entry towards the injector.

The pH measurement at the injector outlet (downstream of the injection) then becomes optional; it is then there only to provide information, so as to confirm the proper control and regulation of the injection of the CO₂.

There then exists, by virtue of the invention, an “intrinsic” anticipation in the system as proposed, without artefact as in the conventional procedure (based on the downstream pH measurement, which requires an anticipation).

It can thus be said, in short, regarding the present invention, that:
a neutralization with CO₂ is carried out while taking into account the pH of the effluent/water before treatment/neutralization and only it.
thus:
   Only the pH of the water/effluent to be treated is considered, not its composition.
   The neutralization is targeted at carrying out only reactions involving an acid and alkaline compounds/bases. To do this, use is made of a preestablished neutralization curve which contains the dose of CO₂ to be used as a function of the initial pH of the water/effluent to be treated.
   A calculation is then made of the flow rate of CO₂ to be injected as a function of the flow rate of incoming water/effluent (the ratio of flow rates corresponds to the dose),
   The treatment process is not controlled as a function of a pH but solely with regard to a flow rate of CO₂: difference between a calculated flow rate of CO₂ (thus a setpoint=dose×measured flow rate of water) and a measured flow rate of CO₂, which makes it possible to direct a valve for regulation of the flow rate of injected gaseous CO₂. The flow rate of water is thus the variable disrupting the control and regulation loop of the invention.
   The main advantage of all this is to be able to immediately neutralize, at the start-up at time 0, the flow of effluent/water as soon as it arrives, which the processes of the prior art do not make possible.

Start-up is thus carried out here directly with a necessary flow rate of CO₂, calculated “blindly” in a way.

Reference may be made to the following documents of the prior art in order to achieve a better understanding of this difference in approach:
document FR-2 767 522A1: this document describes a process for the treatment of water employing control of the amounts of CO₂ and of ozone injected into the water to be treated, as a function of the following data: the flow rate, the temperature, the pH of the water be treated (incoming) and the pH (outlet) of the water treated. The process described in this document determines a setpoint pH, starting from at least one of the parameters measured above, and then adjusts, as a function of the difference between the outlet pH and the setpoint, the proportion of CO₂ to be injected into the water to be treated, and it proceeds according to the same approach for the adjustment of the ozone injection.

It is thus the difference between the setpoint pH and the pH measured at the outlet which will direct a valve for regulation of the injection of CO₂. The flow rate of CO₂ is thus variable, and the target is to regulate the pH. Treatment of the first incoming millilitres of water is thus quite impossible (need for a latency time),
document US2010/230331: this document is concerned mainly with a process for the separation of the solid phases contained in an effluent, comprising a stage of injection of an aggregating agent, and the document describes, in fact, different regulation approaches as a function of different positionings of a pH measurement in the installation.

Reference may be made to FIGS. 6 and 7 of the document, where the authors propose to measure the pH of the water to be treated, to use a curve of dose (g/l for example of CO₂) as a function of the pH on the abscissa, and then to inject the appropriate dose. Mention is never made of the flow rate of water/effluent which enters in their process. In point of fact, this parameter is crucial according to the present invention since it is the variable which influences (disrupts) our loop for control of the process, as was seen above.

It is consequently not known if this document employs a fixed flow rate of orate
processes for the remineralization of drinking water: on the basis of a grade of water to be remineralized (composition, inorganics present, TAC coefficient, and the like), a CO₂ requirement is calculated which will become the setpoint for flow rate of CO₂, on which setpoint regulation of the process will be based.

Lime is subsequently added, which leads this water to become “recharged” with inorganics/TAC. This is thus indeed a remineralization (the starting water is poor in inorganics since it is soft), Consequently this situation is also distant from the present invention, which is a neutralization and not a mineralization, since, in these remineralization processes, the pH is not important; it is indeed the composition of the water to be remineralized which is important and which conditions the requirement curve, and the like, which will thus be very different from that used according to the present neutralization invention.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 illustrates an installation employing a standard solution according to the prior art.

FIG. 2 for its part illustrates an installation which makes it possible to implement the present invention.

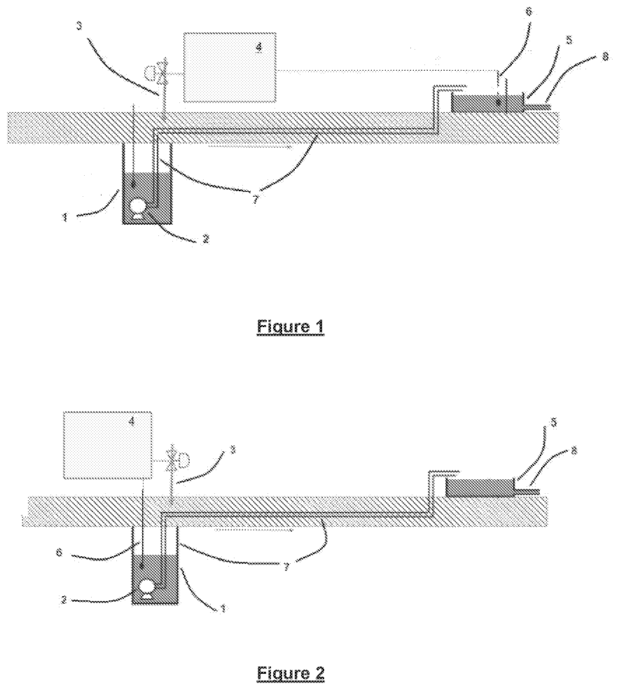

### LIST OF ELEMENT NUMBERS

The following elements are recognized in the figures:
1: entry pit
2: pump
3: injection of CO₂ (in the pipeline 7)
4: automaton
5: outlet basin (optional)
6: a pH measurement carried out in the outlet basin
7: pump outlet pipeline
8: neutralized effluent outlet

### DETAILED DESCRIPTION OF PREFERRED EMBODIMENTS

The following implementational example should be considered: It is concerned with neutralizing an effluent which arrives in the entry pit 1, with a working volume of 2 m³.

The flow rate of incoming effluent is in the vicinity of 30 m³/h and the flow rate of the pump 2, which makes it possible to empty the entry pit, is in the vicinity of 80 h.

In short, when the pit contains 2 m³ of effluent, the pump is set going and empties the pit. At the flow rate of the pump, the emptying takes place in a little more than 2.5 minutes.

Due to the flow rate of effluent which arrives on the pit, this emptying sequence takes place approximately 15 times per hour.

The pipeline 7 at the pump outlet makes it possible to deliver the effluent at approximately 150 m from the entry pit into an open-air inspection hole of approximately 1 m³.

The pipeline is buried over virtually the whole of its course. It has a diameter of 120 mm in order to observe the optimum hydraulic conditions for mixing with a view to neutralizing the effluent. Due to its diameter and its length, the volume of effluent contained in this pipeline between the outlet of the pump and the outlet basin is of the order of 1.7 m³.

Over a “standard” neutralization, the acid injected, in this instance CO₂, is regulated from the pH measurement located at the pipeline end (6), in this instance in the outlet basin. By definition, this basin is at a pH close to neutrality since it corresponds to the final discharged product. During start-up of the emptying pump, it is necessary for a more or less large part to arrive in this basin in order for the pH to increase and for the order for injection to be given to the regulator 4. Consequently, before the CO₂ is injected into and mixed in the effluent, a large part of the volume of effluent from the pipeline will be poured into the outlet basin without being treated and thus into the natural environment or into the drainage system, due to the small size of the outlet basin.

In this example, as the volume contained in the pipeline is close to 1.7 m³, and the hourly frequency of start-up of the pump close to 15 times per hour, between ⅔ and ¾ of the effluent will not be correctly treated with a neutralization regulated in a standard manner in-line.

In order to overcome this problem, the injection of CO₂ might be forestalled but then, as the injection is no longer directly proportional to the requirement, the risk exists of overacidification or of overconsumption.

Of course, it is also possible, in order to solve the problem, to produce a large-sized outlet basin, in order “to dampen” the frequent start-ups of the pump, but this cannot always be carried out due to problems of spatial requirements and/or of cost.

In FIG. 2, an unvarying incoming effluent flow rate is assumed. Consequently, it is not necessary to include a flowmeter in the installation.

The same operating conditions should then be considered here as above, that is to say:
A flow rate of effluent to be neutralized of approximately 30 m³/h.
An entry pit with a working volume of 2 m³, and thus, when there are 2 m³ of effluent in the pit, the emptying pump is set going.
The pump has a fixed flow rate of 80 m³/h; consequently, it will be started up approximately 15 times per hour in our example.
A buried pipeline with a diameter of 120 mm, i.e. a residual effluent volume in this pipeline of the order of 1.7 m³.
A discharge basin before the discharge into the natural environment or into the drainage system with a working volume of approximately 1 m³.

In accordance with the present invention, the method of regulation proposed operates in the following way:
The pH of the effluent is measured upstream of the injection of CO₂ into the pipeline (in this instance, the pH is measured in the entry pit and the acid to be injected is CO₂)
A curve corresponding to the dose of CO₂ to be injected for a volume of effluent (1 litre, 1 m³) was predefined and entered in the regulator/automaton (predefined, for example, by tests carried out upstream)
At start-up of the pump, an optional rate valve opens to make possible the injection of the CO₂; the amount injected corresponds to the preestablished dose multiplied by the effluent flow rate (measured flow rate, or flow rate of the pump), the opening being determined by the automaton/regulator.
At shutdown of the pump or in the absence of an incoming flow of the effluent, the injection of CO₂ is interrupted by closure of a valve or by any other shutdown means.

With this method of regulation, all of the effluent contained in the pipeline is neutralized from the start-up of the emptying pump and the discharges are always in accordance without modification of the installation (no need to enlarge the outlet basin, for example).

The present invention then relates to a method for the treatment of an effluent, which comprises the injection, into the effluent, of CO₂ or of a gas mixture comprising CO₂, being characterized by the implementation of the following measures:

a) a measurement of the pH of the effluent is carried out upstream of the point of injection of the CO₂ or of the mixture, in the process;

b) a curve of dose of CO₂ to be injected as a function of the pH of a medium for a predetermined volume in litres or in cubic metres was determined beforehand, a curve determined, for example, by calculations or from experimental tests, and this curve is entered into a regulator or automaton capable of controlling the operation of the process;

c) the presence (the arrival) of a flow of effluent to be treated is detected, for example by setting a pump going or also by the detection of a flow using a flowmeter;

d) the value of the flow rate of effluent existing at the inlet of the process is available;

e) the dose of CO₂ corresponding to the measured pH is read on said curve, and a calculation is made of the flow rate of CO₂ to be injected as a function of the incoming water/effluent flow rate, the ratio of flow rates corresponding to said dose;

f) said flow rate of CO₂ or of mixture is injected into the effluent;

g) the injected flow rate is regulated at the setpoint value determined in stage e).

The present invention also relates to an installation for the treatment of an effluent, carrying out the injection, into the effluent, of CO₂ or of a mixture comprising CO₂, comprising:

i) a means for measurement of the pH of the effluent, which means is located upstream of the point of injection of the CO₂ or of the mixture in the installation;

ii) a means of detection of the arrival of a flow of effluent to be treated, for example a pump or also a flowmeter;

iii) a means for measurement of the flow rate of effluent to be treated existing at the inlet of the process;

iv) a regulator or automaton capable of controlling the treatment, as a function of its analysis of a curve of dose of CO₂ to be injected as a function of the pH of a medium for a predetermined volume in litres or in cubic metres, a curve obtained, for example, by calculations or from experimental tests, the automaton being capable of carrying out the following actions:
of reading, on said curve, the dose of CO₂ corresponding to the measured pH, and of calculating the flow rate of CO₂ to be injected as a function of the incoming effluent flow rate, the ratio of flow rates corresponding to said dose;
of ordering the injection of said flow rate of CO₂ or of mixture into the effluent;
of regulating the injected flow rate at the setpoint value determined during said calculation.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined here n as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

While embodiments of this invention have been shown and described, modifications thereof may be made by one skilled in the art without departing from the spirit or teaching of this invention. The embodiments described herein are exemplary only and not limiting. Many variations and modifications of the composition and method are possible and within the scope of the invention. Accordingly the scope of protection is not limited to the embodiments described herein, but is only limited by the claims which follow, the scope of which shall include all equivalents of the subject matter of the claims.

What is claimed is:

1. A process for treatment of an effluent, which comprises an injection (3), into the effluent, of CO₂ or of a mixture comprising CO₂, comprising the steps of:
a) carrying out a measurement (6) of the pH of the effluent upstream of the point of injection of the CO₂ or of the mixture;
b) determining a curve of dose of CO₂ to be injected as a function of the pH of a medium for a predetermined volume in litres or in cubic metres beforehand;
c) detecting a flow of the effluent to be treated, and injecting the dose of CO₂ or of the mixture, wherein a value of a flow rate of the effluent existing at the inlet of the process is available;
d) reading on said curve, the dose of CO₂ corresponding to the measured pH, wherein a calculation is made of a flow rate of CO₂ to be injected as a function of an incoming effluent flow rate;
e) injecting said flow rate of CO₂ or of the mixture into the effluent; and
f) regulating the injected flow rate of CO₂ at a setpoint value determined in step d).

2. The process of claim 1, further comprising entering the determined curve into a regulator or automaton (4) capable of controlling the operation of the process.

3. The process of claim 2, wherein the curve is determined by calculations.

4. The process of claim 2, wherein the curve is determined from experimental tests.

5. The process of claim 1, wherein the detecting step c) includes setting a pump going.

6. The process of claim 1, wherein the detecting step c) includes detecting a flow by a flowmeter.

7. The process of claim 1, wherein the dose of CO₂ or of the mixture is determined by said curve and multiplied by the flow rate of the effluent to be treated.

8. The process of claim 1, wherein the ratio of the flow rate of CO₂ and the incoming effluent flow rate corresponding to said dose.

9. A system for treatment of an effluent; carrying out an injection (3), into the effluent, of CO₂ or of a mixture comprising CO₂, comprising:
i) a pH measurement means (6) configured and adapted to measure the pH of the effluent, which is located upstream of the point of injection of the CO₂ or of the mixture in the system;
ii) a pump or a flowmeter, configured and adapted to detect the arrival of a flow of the effluent to be treated;
iii) a device configured and adapted to measure the flow rate of the effluent to be treated existing at the inlet of the system; and
iv) a regulator or automaton (4) configured and adapted to be capable of controlling the treatment, as a function of its analysis of a curve of dose of CO₂ to be injected as a function of the pH of a medium for a predetermined volume in litres or in cubic metres, the automaton configured and adapted to be capable of carrying out the following actions of:
reading, on said curve, the dose of CO₂ corresponding to the measured pH_{;}
and calculating the flow rate of CO₂ to be injected as a function of the incoming effluent flow rate;
ordering the injection of said flow rate of CO₂ or of the mixture into the effluent; and
regulating the injected flow rate at a setpoint value determined during said calculation.

10. The system of claim 9; wherein the curve is obtained by calculations.

11. The system of claim 9, wherein the curve is obtained from experimental tests.

12. The system of claim 9; wherein the ratio of the flow rate of CO₂ and the incoming effluent flow rate corresponding to said dose.

13. The process of claim 9, wherein the dose of CO₂ or of the mixture is determined by said curve and multiplied by the flow rate of the effluent to be treated.
